(19) United States
(12) Patent Application Publication
(10) Pub. No.: US 2004/0176026 A1
(43) Pub. Date: Sep. 9, 2004

(54) Covert spatially separated antenna package for repeater

(75) Inventors: Kenneth M. Gainey, Satellite Beach, FL (US); James A. Proctor JR., Melbourne Beach, FL (US); John A. Regnier, Palm Bay, FL (US); Jonathan L. Hughes, Melbourne, FL (US); Stefan Haenggi, Niederglatt (CH); Michael J. Lynch, Merritt Island, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tantivy Communications, Inc., Melbourne, FL (US)

(21) Appl. No.: 10/462,582

(22) Filed: Jun. 16, 2003

Related U.S. Application Data
(60) Provisional application No. 60/390,091, filed on Jun. 21, 2002.
(60) Provisional application No. 60/390,093, filed on Jun. 21, 2002.

(51) Int. Cl. H04B 7/14; H04B 7/15

(52) U.S. Cl. 455/7; 455/11.1

(57) ABSTRACT

A repeater for a wireless network in which a signal radiation path provided by building wiring is used to provide spatial separation between at least two radiating points. The repeater is preferably packaged into a housing that is suitable for use as an Alternating Current-to-Direct Current (AC/DC) transformer (or wall wart). If the radiating point includes at least one antenna, the antenna may also be incorporated within the transformer housing. The radiating points can be are provided by at least two antennas, in which case the building wiring includes a coaxial cable, such for carrying video or cable signals. The building wiring may also be standard Alternating Current (AC) three wire conductor cable which may or may not be placed within building walls. In this implementation, the radiating point is determined by a matching circuit. A frequency conversion circuit can cause the radiation from at least one radiating point to occur at a carrier frequency that is different from the carrier frequency of the other radiating point.

### RELATED APPLICATION(S)

This application claims the benefit of U.S. Provisional Application No. 60/390,091 filed Jun. 21, 2002 and U.S. Provisional Application No. 60/390,093 filed Jun. 21, 2002. The entire teachings of the above application(s) are incorporated herein by reference.

### BACKGROUND OF THE INVENTION

The present invention relates generally to wireless communication systems and in particular to a technique for distributing wireless signals.

Wireless communication networks of various types, including digital cellular systems, Wireless Local Area Networks (WLANs) and Personal Area Networks such as Bluetooth are increasingly viewed as an ideal connectivity solution for many different applications. These can, for example, be used to provide access to wireless equipped personal computers within home networks, mobile access to laptop computers and Personal Digital Assistants (PDAs) as well as for robust and convenient access in business environments. Indeed it is estimated at the present time that at least 25% of all laptop computers are shipped from the factory with wireless networking equipment already installed. Certain microprocessor manufacturers, such as Intel, have even incorporated wireless capability directly into their processor chip platforms. It is clear that these and other initiatives will continue to drive the integration of wireless equipment into computing equipment and the demand for wireless networks of all types.

In these many wireless networks, such as cellular mobile telephones, a central node, referred to as a base station or access point contains a computer controlled transceiver that allows connection to wired networks such as local area networks, wide area networks or Public Switched Telephone Networks (PSTNs). The access point includes an antenna for transmitting forward link radio frequency signals to remote field units (stations) located within range. The access point is also responsible for receiving reverse link radio frequency signals transmitted from the remote stations. The remote stations also contain antenna apparatus and receivers for reception of the forward link signals and for transmission of the reverse link signals.

One group of wireless local area network equipment standards is known as Institute of Electrical and Electronic Engineers (IEEE) 802.1 1 standard. These standards also support a single hub topology that provides wireless communication to a number of stations. In this architecture a number of stations may communicate through a single access point to a hard wired link. Unfortunately the range of this equipment is typically expected to be about 500 meters. In practice the range is typically much smaller than that, especially when access points are deployed within buildings.

There is often a need therefore to increase the coverage area afforded by an access point. This can be accomplished by increasing the height of an antenna, or increasing transmit power levels. However, these solutions cannot remove blind spots. Within such environments in the interior of a building signal reflections off of furniture, building contents and even the infrastructure of building itself are quite common. Thus signal fading studies have proven that line of sight propagation is not typically the dominant propagation mode. Within a building, metal, concrete, and other structures typically provide a signal fading characteristics for over the air propagation that in turn requires wireless signal transmissions to be carried out at higher power levels than would otherwise be necessary for line of sight environments.

Another solution is to deploy a greater number of access points to provide coverage in the areas of a building where it is required. While this eliminates blind spots, it of course increases the total capital cost required for network equipment deployment. While the cost of access points has dropped markedly in the past few years, to price points below 100 dollars, for home users, deployment of more than one or two access points can be cost prohibitive.

Various types of distribution networks have also been suggested in commercial deployments where multiple remote antennas are connected to centralized base station equipment. In this approach, such as suggested in U.S. Pat. No. 5,381,459, cable television or fiber optic networks can be used to connect multiple antennas that are deployed within remote coverage areas. This approach couples the antennas to transceivers using time or frequency division multiplexing, in order to avoid interference with the other signals being carried by the cables such as Cable Television (CATV) signals.

Others have suggested that wireless system signals can be carried within buildings using existing power line wiring. For example, U.S. Pat. No. 5,832,364 describes a Radio Frequency (RF) distribution system in which modulated RF carrier signals produced by a base station (access point) are coupled to building power line wiring. A number of antennas are dispersed at various locations within the building, and coupled to the power line wiring. This permits the modulated RF signals to pass between the base station transreceiver and the antennas over the in-building power line wiring.

Access points generally require interconnection cabling, but are still typically the dominant method for providing radio frequency coverage in most deployments. Still others have proposed the use of a number of repeating transceivers. Each repeater is assigned a coverage area within a predetermined location. Such repeaters are described to some extent in U.S. Pat. No. 6,005,884.

In general, a repeater regenerates a wireless signal in order to extend the range of the existing network infrastructure. A repeater does not physically connect by wire to any other part of the network. Instead the typical repeater receives radio signals from an access point, user device, or another repeater and retransmits them. A repeater located in between an access point and a distant user can thus act as a sort of relay for signals or encoded frames traveling back and forth between the user and the access point. Certain wireless LAN access points available on the market have repeating functions already built into them, such as the model DWL-900AP access point available from D-Link Systems, Inc of Irvine, Calif. The Air Sation ProSeries WAL-AWCG available from Buffalo Technology, Inc. of Austin, Tex. is one example of a standalone type repeater.

Each of these solutions is less than satisfactory for a number of reasons.

Solutions such as remote antenna drivers for cable television networks are not typically designed for use in home networks or inexpensive installations, but are rather geared more for deployment by the operators of public access networks such as cellular telephone network operators.

Repeaters which simply repeat radio signals received potentially reduce network throughput. For example, in the case of a wireless local area network where signals are transmitted and received on the same radio channel, each repeater must receive and transmit on the same RF channel. This effectively doubles the number of frames that are sent and therefore can reduce the available bandwidth.

Wireless access points that have repeater functionality built into them are not the most cost effective solution since they add both the wireless access point functionality in itself and that associated cost as well as the cost of the repeater in the same unit.

### SUMMARY OF THE INVENTION

The present invention is a repeater for a wireless network in which a bi-directional signal radiation path provided by wiring is used to provide spatial separation between at least two radiating points. The repeater is preferably packaged into a housing that is suitable for use as an Alternating Current-to-Direct Current (AC/DC) transformer (power supply housing or wall wart).

If the radiating point includes at least one antenna, the antenna may also be incorporated within the transformer housing.

In one embodiment, the radiating points are provided by at least two antennas, and the building wiring includes a coaxial cable, such as is commonly used for carrying video or cable signals, that is interconnected between the two antennas.

In other embodiments, the building wiring may be standard Alternating Current (AC) conductor cable that may or may not be placed within building walls.

In still other embodiments, at least one of the radiating points may be provided by the building wiring itself. In this implementation, the radiating point is determined by a matching circuit.

In still other arrangements, an up-conversion or down-conversion circuit can cause the radiation from at least one radiating point to occur at a carrier frequency that is different from the carrier frequency of the other radiating point.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram showing deployment of an access point (base station) and one configuration of a repeater according to the present invention.

FIG. 2 is an exterior view of a preferred packaging format.

FIG. 3 is a block diagram showing one possible arrangement of electrical components within the repeater.

FIG. 4 is another possible configuration.

FIG. 5 is an alternative embodiment where building wiring is used to provide a radiating point.

FIG. 6 is a circuit diagram for the embodiment of FIG. 5.

FIG. 7 is an alternate of the embodiment of FIG. 6.

FIG. 8 is a diagram illustrating how cost may be reduced for a network using Time Division Duplex (TDD) signaling.

FIG. 9 is an alternate arrangement for FIG. 8.

### DETAILED DESCRIPTION OF THE INVENTION

A description of preferred embodiments of the invention follows.

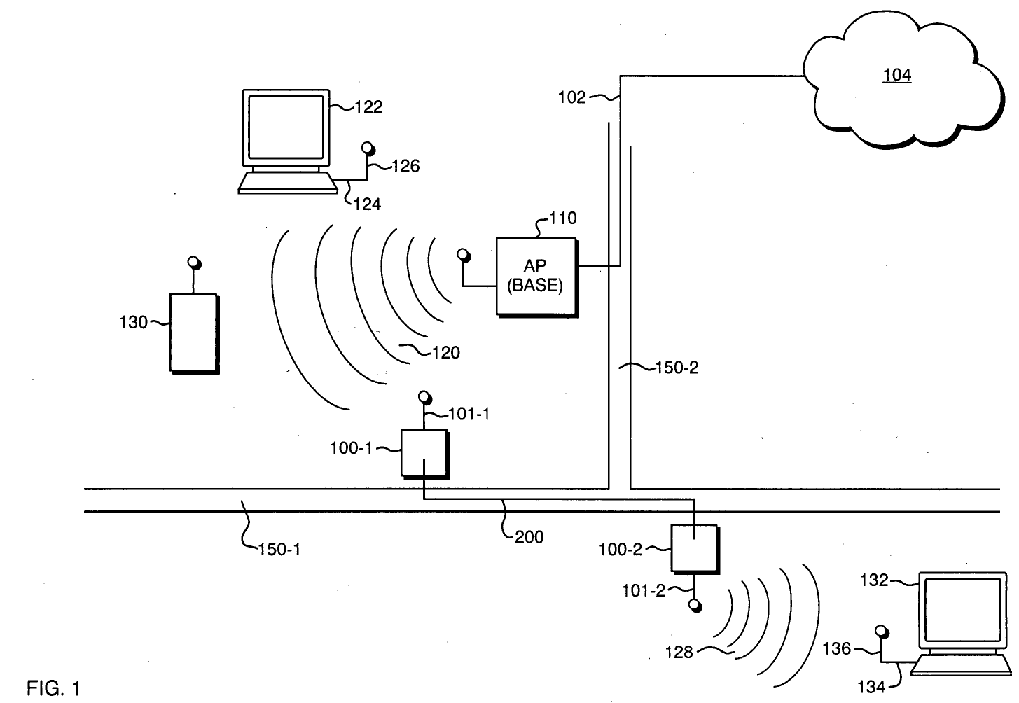

Turning attention now to the drawings, FIG. 1 is a schematic diagram of a building in which repeaters 100-1, 100-2 are deployed according to the present invention. As is now quite common, a broadband network connection 102 such as may be provided by a cable modem, Digital Subscriber Line (DSL) telephone line, or other wired accesses point is provided to a broadband network 104 such as the Internet or private or a Public Switch Telephone Network (PSTN). An access point (AP) 110 also referred to as a base station, is connected to the broadband connection 102. The access point 110 provides or radiates wireless signals 120 within a defined area of the building. Wireless signals 120 provide wireless data connectivity to, for example, a laptop computer 122, having associated with it wireless interface card 124 and antenna 126. Other devices such as hand held mobile telephone 130 may also be able to communicate with the access point 110. The mobile telephone 130 is representative device only it should be understood that other small devices such as Personal Digital Assistance (PDAs), and combination PDA/cellular telephone devices may also be utilized. The wireless network 120 in the illustrated embodiment uses a Wireless Local Area Network (WLAN) protocol such as the 802.11 a, b, or g standard. These Time Division Duplex (TDD) methods cause both transmit and receive signaling on the same Radio Frequency (RF) channel. It should be understood that emerging cellular telephone protocols such as those defined in the 3G standards CDMA, TDMA, and other cellular telephone standards may also be utilized to provide wireless connectivity including still other standards such as Bluetooth, Hyperlan and the like.

A second portable computer 132 is also located in the building and also having a wireless access card 134 and antenna 136, but in a different room. It is therefore outside the range of the access point given that walls 150-1 and 150-2 are attenuating the RF signals 120 radiating directly from the access point 110. Thus no signals 120 will directly reach portable computer 132 from the access point 110.

However, the repeaters 100-1, 100-2 cooperate to extend the range of the access point 110 so that reradiated wireless signals 128 can reach the portable computer 132. As will be understood shortly, the repeaters 100 are packaged in a most convenient form factor, as Alternating Current/Direct Current (AC/DC) converters or “wall warts” that can be conveniently inserted into electrical power outlets in a manner that is quite familiar to consumers. In this implementation, the repeaters 100-1, 100-2 are interconnected by a special purpose cable 200 which is located within the building such as within or along the walls 150-1, 150-2. Repeaters 100-1 and 100-2 and cable 200 provide spatial separation between the associated antennas 101-1 and 101-2. This technique prevents oscillation that is coupled between the input and output of the repeaters. Such spatial separation is often desirable in order to achieve enough attenuation between the transmit and receive paths through the repeaters 100, in order to keep regenerative feedback from preventing the repeaters to work.

The cable 200 not only allows radio signals to be carried over coaxial type connection but also provides for connection.

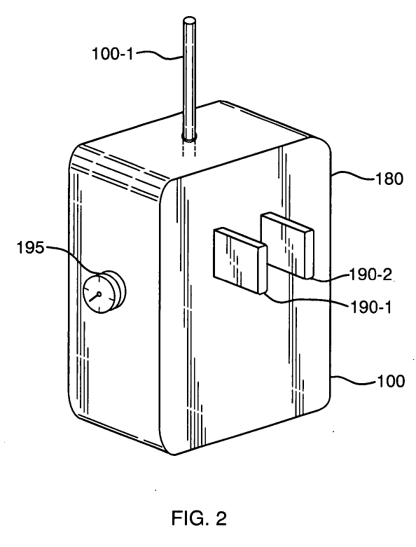

FIG. 2 is a more detailed view of a typical repeater 100-1 or 100-2. Here is seen the familiar AC/DC package 180 which is typically formed of a thermo plastic housing. Prongs (plugs) 190-1, 190-2 provide connectivity to an AC power source. A coaxial connector 195 placed on the exterior portion of the housing 180 provides for a connection to an optional coaxial cable that is needed in some embodiments.

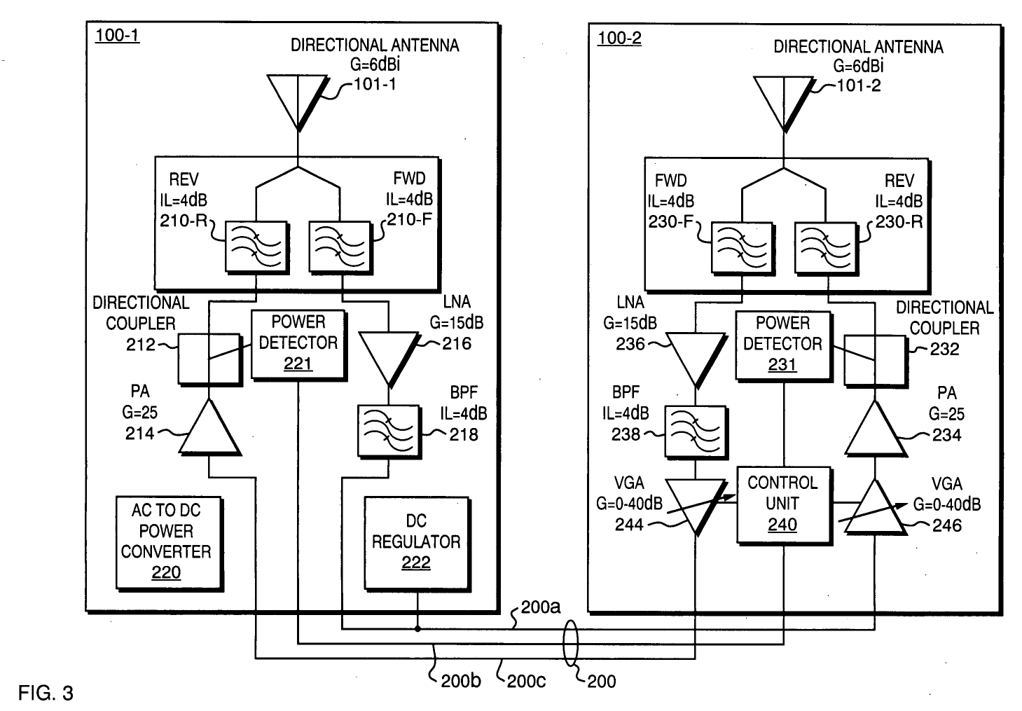

FIG. 3 is a more detailed view of the electrical components inside the repeaters 100-1, 100-2. The first unit 100-1 consists of the antenna 101-1 as previously described and a pair of band pass filters including a reverse band pass filter 210-r and a forward band pass filter 210-f. In the forward link direction (from the access point 120 towards the station 13) forward band pass filter 210-f couples received RF signals to low noise amplifier 216 having a gain of approximately 15db. The output is then provided to another bandpass filter 218 is fed to a first RF conductor 200-a on the cable 200. A direct current regulator 222 may provide power to the circuits in units 100-1 and 100-2. In this instance, the DC power and RF signal are carried on the same cable to save on wiring, i.e., the DC supply powers the circuits in 100-2. As will be understood shortly, cable 200 may be existing building wires or a special cable sold with the unit 100.

Reverse link signals received from the other (primary) unit 100-2 are fed to power amplifier 214 having an appropriately set gain. A directional coupler 212 couples signal energy to the reverse link final stage bandpass filter 210-r prior to coupling the signal to the antenna 101-1. A power detector 221 can provide a signal on conductor 200-b that is used by the control unit 240 and the other repeater unit 100-2. The power detector is utilized to in some implementations determine when signals are present in either the forward or reverse link in unit 100-1, in order to control the state of the amplifiers 244 and 246 accordingly.

In this configuration, control functions remain in the primary repeater 100-2 with some of the RF electronics being moved to a first module 100-1. The cable 200 required to support this configuration requires two coaxial cables conductors 200-a and 200-c as well as a cable that is 200-b is capable of carrying a digital control line. AC/DC power converter 220 in the module 100-1 provide power to the components therein.

The other (primary) unit 100-2 is similar to unit 100-1 but contains a control unit 240 and variable gain amplifiers 244-246 to set transmit power levels. Thus signals received in a forward link direction at forward bandpass filter 230-f are fed to Low Noise Amplifier (LNA) 236 and bandpass filter 238. Similar to the arrangement in the unit 100-1, signals intended for the reverse link are first received at power amplifier 234 are fed through directional coupler 232 out through reverse filter 230-r to the antenna 100-2.

The control unit 240 receives signals from the power detectors 221 and 231 associated with each antenna, providing a capability for setting a power level of the variable amplifiers 244 and 246. As will be understood in connection with other embodiments, control unit 240 might control the signal chain in other ways such as by simply switching off amplifiers 244 and 246. In the illustrated embodiment the variable gain amplifiers are typically used in a system such a Code Division Multiple Access modulation system in which the forward and reverse link paths are carried on separate carrier frequencies at the same instant in time. However, in other situations involving the use of other wireless modulation schemes such as Time Division Duplexing (TDD), (such techniques being utilized with 802.11 wireless LANs, but also with 3G cellular networks such as UMTS, TDD-SCDMA, and TDD-WCDMA, as well as Bluetooth in the like) only one path, the transmit or receive path, is active at one instant in time. Thus the control unit can operate accordingly and enable only one amplifier at a time.

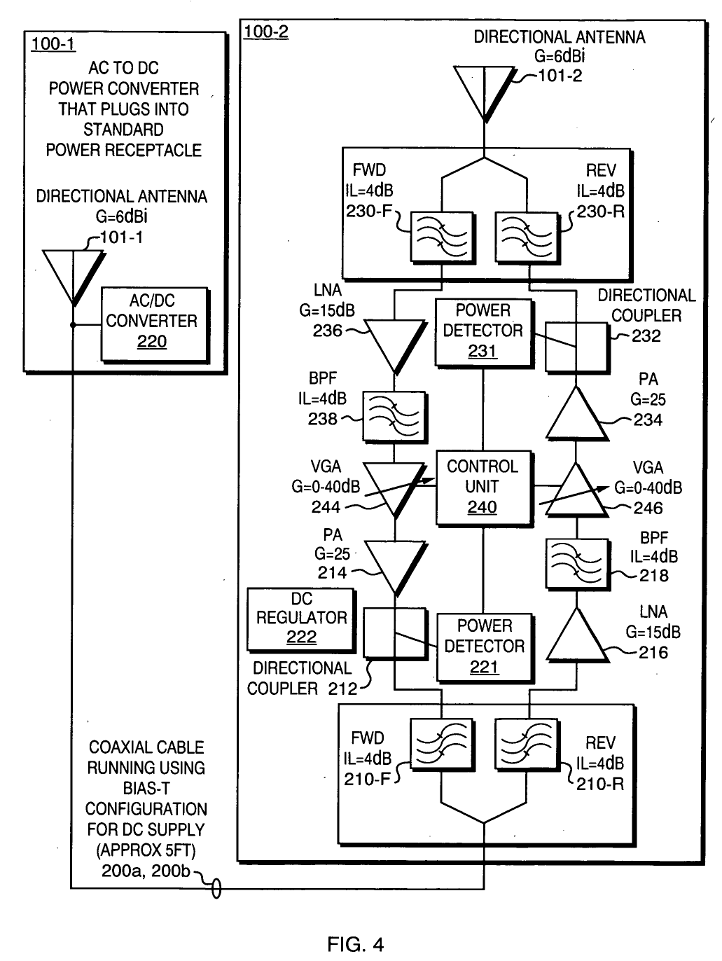

FIG. 4 is alternate arrangement of the components whereby most of the electronics have been moved to the primary unit 100-2 and the secondary unit 100-1 has simply the directional antenna and AC/DC converter contained therein. In this configuration the cable 200 can be a coaxial cable 200-a with another single conductor for a DC power supply 200-b. The various components 230, 232, 234, 236, 238, 240, etc. all operate as in the previously described embodiment for FIG. 3. Although the FIG. 4 embodiment provides spatial separation at the antennas 101, providing all of the radio frequency gain in one package can cause greater circuit layout challenges.

With either implementation, however, spatially separated antennas 101-1 and 101-2 may be provided with a separation of many feet. Extensions to coverage within a building are therefore easily provided for, and dead spots in wireless cell networks.

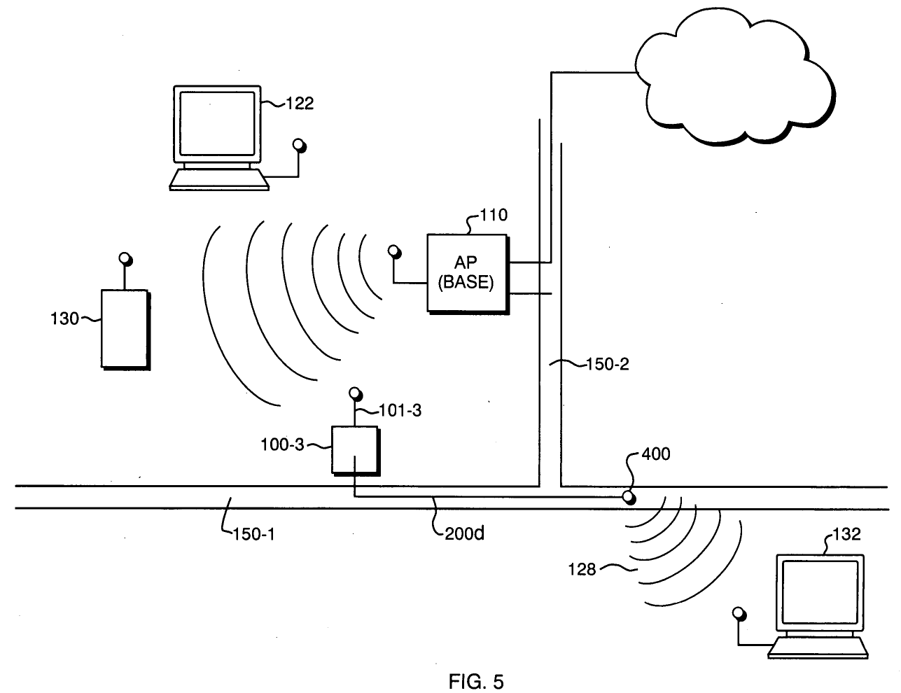

FIG. 5 shows an alternate embodiment of the invention that makes use of a single repeater 100-3. The situation is otherwise as before with the access point 110 capable of directly providing wireless connectivity to devices 122 and 130, but not to device 132 because of attenuation provided by building walls 150-1 and 150-2. Here, however, the cable 200-d may simply be the AC wiring that is typically already within the walls 150-1, 150-2. A radiating point 400 within the wiring 200-d provides a point source for radiation of wireless signals 128 to the portable computer 132. It should be understood that the exact location or number of radiating points 400 will depend on the building geometry and even the geometry of the wiring itself and thus results with this approach may be unpredictable.

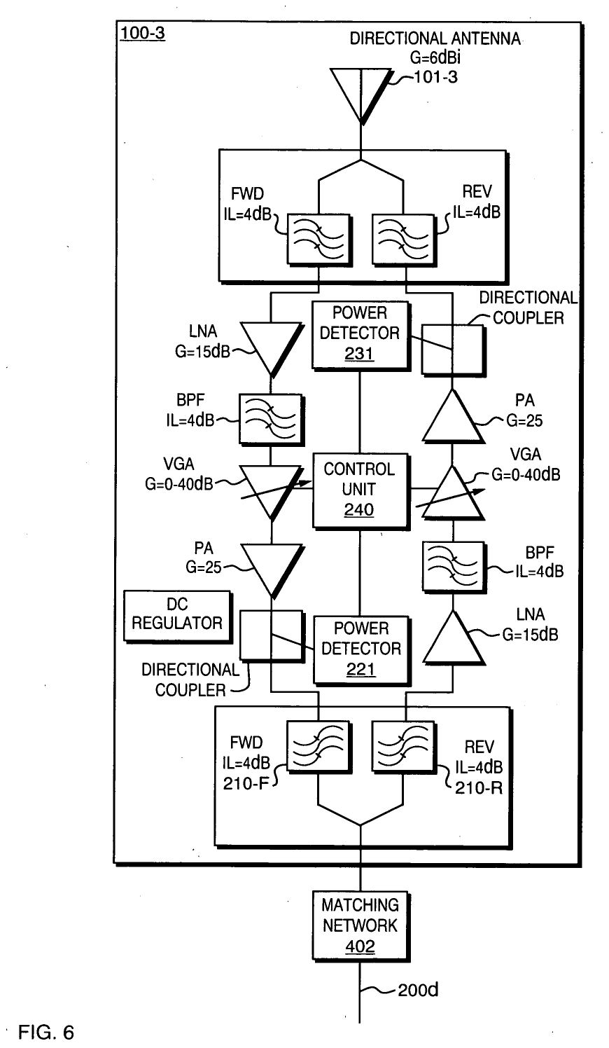

Another manner of accomplishing this is more evident from the drawing of FIG. 6. Here the device 100-3 is seen to include most of the same components of the embodiment of FIG. 4, however a matching network 402 is provided. The matching network 402 takes the signals provided to and from the reverse filter 210-r and forward filter 210-f and providing for impedance matching to the building wiring 200-d. The matching allows for the best most efficient transfer of signal to and from the radiating point on cable 200-d and the electronics within the unit 100-3. Additional filtering may be associated with the matching network in order to filter out of band noise before the signals are provided to the amplification stages.

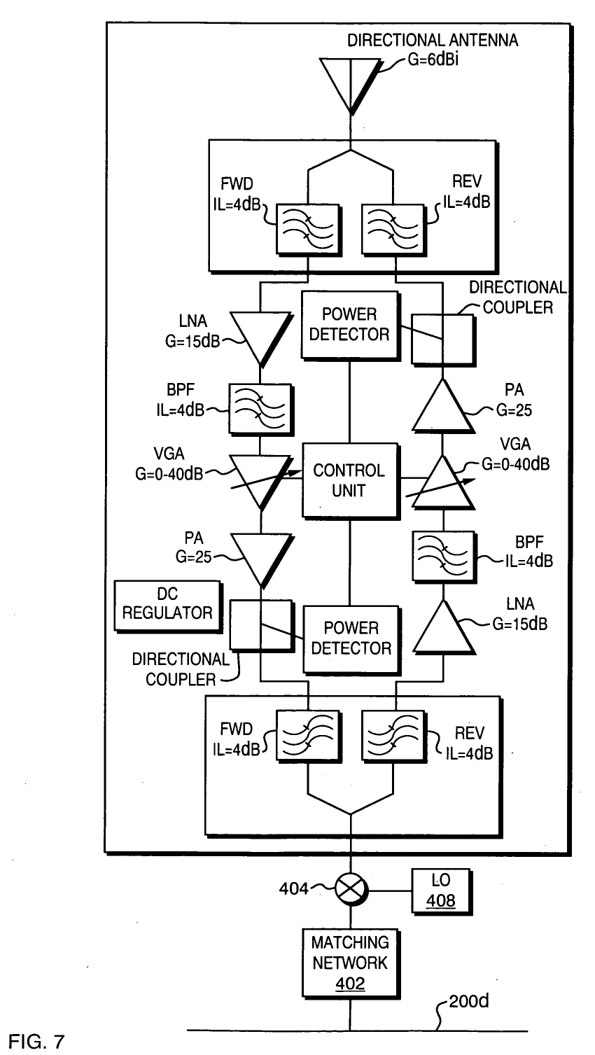

FIG. 7 is a diagram quite similar to that of FIG. 6, but showing a mixer 404 and local signal reference generator 408. These serve to shift the carrier frequency of signals prior to providing them to the matching network 402. This frequency shift implementation may be desirable in some structures where signals 120 are not at the best carrier frequencies to be carried over the AC building wiring 200-d. This can be advantageous where the building has other types of cables installed, such as coaxial (CATV) or LAN cables. The shift in carrier frequency will depend upon the type of wiring available. For example, if only AC wiring is present, the signal should be shifted to a relatively low IF.

In the case of a TDD network, the device may provide amplification in only one direction at a time. This can be further efficiently accomplished by operation of the power detectors and control units as well as reducing the parts count within the units 100.

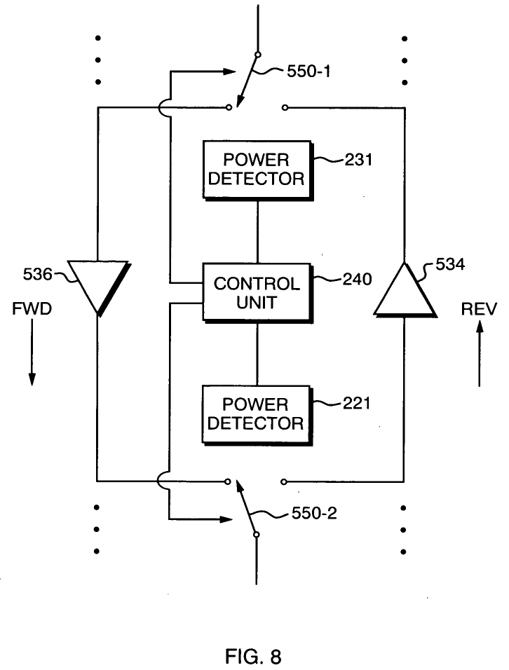

One such embodiment is shown in FIG. 8. Here, a simplified device has a single amplifier 534, 536 associated with each direction of transmission. It should be understood that forward and reverse filtering 230-f, 230, 210 would still be desirable in this embodiment although they are not shown in the drawing. The power detector 221, 231 provide signals to control unit 240, as before indicating signal levels on the various respective antenna connections.

While the amplifiers 534 and 536 may again be gained controlled amplifiers what is important to recognize here is that the control unit 240 also operates switches 550-1 and 550-2. The switches 550 control which signal paths through the unit are presently active. For example, in the configuration shown in FIG. 8 the path associated with the forward direction is enabled. When the switches are moved to the position not shown in the drawing, this enables the reverse path through amplifier 534. While a single amplifier 534, 536 is shown in each of the signal paths it should be understood that embodiments that make use of a chain of amplifiers (as shown in a previous embodiment of FIG. 6) for example, having LNA, PGA and PAs, associated with each path and associated filters and so forth could also be used. However in order for the unit 100 to be as inexpensive as possible, a cost benefit analysis would determine exactly how many amplifiers are necessary in the chain.

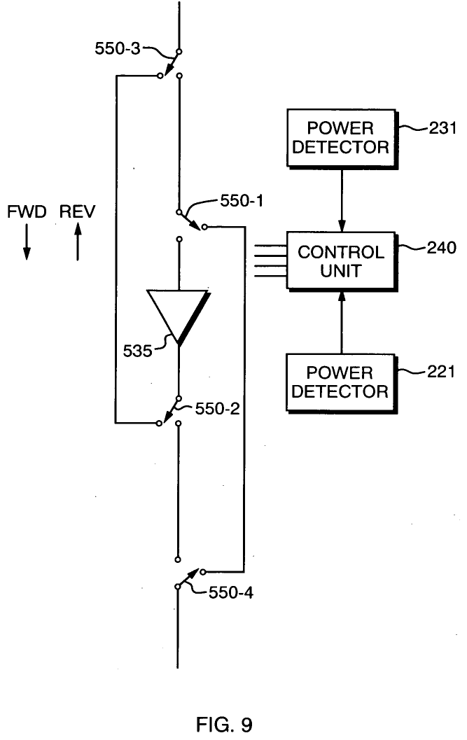

Finally, FIG. 9 is a diagram of an implementation similar to that of FIG. 8 however showing only a single amplifier 535. Here the control unit 240, and power detectors 221, 231 control the four switches 550-1, 550-2, 550-3, 550-4 to give two different signal paths through the same amplifier 535. In one configuration, the switches provide for forward signal propagation, and in the other configuration they provide for reverse direction propagation. That is, with the switches in one position, signal flow may be from the top to the bottom of the page through the amplifier 535 with the switches in the other position, signals flow up from the bottom of the page passing to the right of switch 530-4 in position B to switching position 550-1 in position B (control lines are not shown in the figure for clarity's sake).

While this invention has been particularly shown and described with references to preferred embodiments thereof, it will be understood by those skilled in the art that various changes in form and details may be made therein without departing from the scope of the invention encompassed by the appended claims.

What is claimed is:

1. A bi-directional wired repeater device for a wireless network comprising:
at least two radiating points that are spatially separated by at least several feet;
a signal path provided to interconnect the two radiating points;
repeater radio circuitry, for receiving at least one radio signal from at least one of the radiating points and transmitting such received signal at another one of the radiating points;
and a housing, for packaging at least a portion of the repeater radio circuitry.

2. A repeater device as in claim 1 wherein the housing is suitable for use as an Alternating Current-to-Direct Current (AC/DC) transformer.

3. A repeater device as in claim 1 wherein at least one radiating point is provided by an antenna.

4. A repeater device as in claim 3 wherein the antenna is incorporated into the housing.

5. A repeater device as in claim 1 wherein the radiating points are provided by at least two antennas, and the building wiring is a coaxial cable.

6. A repeater device as in claim 1 wherein the wired signal path is standard Alternating Current (AC) two conductor cable.

7. A repeater device as in claim 1 wherein the signal path is placed within at least one wall of the building.

8. A repeater device as in claim 1 wherein at least one of the radiating points is provided by the signal path.

9. A repeater device as in claim 1 additionally comprising:
a switch, to select either of a first or second direction in the repeater radio circuitry to be active at a given time.

10. A repeater device as in claim 1 wherein a frequency conversion circuit causes the radiation transmitted from at least one radiating point to be repeated at a carrier frequency that is different from the carrier frequency of the signal received at the other radiating point.
